(19) United States
(12) Patent Application Publication
(10) Pub. No.: US 2018/0316195 A1
(43) Pub. Date: Nov. 1, 2018

(54) MINIMIZING LITHIUM PLATING IN A LITHIUM ION BATTERY

(71) Applicant: GM GLOBAL TECHNOLOGY OPERATIONS LLC, Detroit, MI (US)

(72) Inventors: Mark W. Verbrugge, Troy, MI (US); Brian J. Koch, Berkley, MI (US); Daniel R. Baker, Romeo, MI (US)

(21) Appl. No.: 15/581,296

(22) Filed: Apr. 28, 2017

(51) Int. Cl. H02J 7/00; H01M 10/0525; H01M 10/44; H01M 4/505; H01M 4/587; H01M 4/525

(52) U.S. Cl. CPC H02J 7/007; H01M 10/0525; H01M 4/525; H01M 4/505; H01M 4/587; H01M 10/44

(57) ABSTRACT

During the charging of lithium-ion batteries, comprising graphite anode particles, the goal is to intercalate lithium into the anode materials as LiC₆. But it is possible to conduct the charging process at a rate that lithium is undesirably plated, undetected, as lithium metal on the particles of graphite. During an open-circuit period of battery operation, immediately following such a charging period, the presence of lithium plating can be detected, using a computer-based monitoring system, by continually measuring the cell potential (Vcell) over a brief period of open-circuit time and then determining dVcell/dt (mV/s) over a like period of time. It is found that the presence of a discontinuity in the derivative curve (a local maximum) reliably correlates with plated lithium on the graphite particles of the anode.

### TECHNICAL FIELD

This disclosure pertains to lithium-ion batteries. More specifically it pertains to the introduction of lithium into the graphite anode of a lithium-ion cell during the charging of the cell.

### BACKGROUND

Lithium-based batteries are finding increasing usage in powering electric motors and other devices in automobiles and in powering other consumer devices. High energy-capacity lithium-ion batteries are required for use in powering electric motors for driving the wheels of an automobile, and in many such applications a multi-cell, high voltage, lithium-ion battery is used. The use of such batteries in such applications requires that the electrochemical cells of the battery are continually discharged and re-charged.

During discharge of a lithium ion battery, lithium ions are removed (de-intercalated) from the anode material and released into a contacting electrolyte. Electrons are simultaneously released into an anode current collector and then into an external power-requiring circuit, like an electric motor powering a vehicle. With the release of electrons, the anode is negatively charged. The lithium ions are conducted through the electrolyte, often a liquid solution of a lithium salt, to the cathode (the positive electrode during cell discharge). Electrons, entering the cathode from the external circuit, facilitate the intercalation of lithium into the material of the cathode. The flow of lithium ions is reversed when the electrochemical cells in the battery are being re-charged by imposing a cell potential that drives reduction at the anode and oxidation at the cathode. Electrons are forced to flow from the cathode to the anode. The composition of each electrode material must accommodate the transport of lithium into and out of the respective electrode materials (intercalation/de-intercalation). The continued capacity of each cell, during a large number of repeated charge-discharge cycles, depends in substantial measure on the effective movement of lithium into and out of the materials, often particulate materials, of the opposing electrodes.

In lithium battery materials used in powering electric motors driving automobiles, for example, there is interest in the rate at which the anode of each cell (the negative electrode during cell discharge) can be recharged so that the battery can continue its function in the powering the vehicle and devices on the vehicle. There remains a need for improvement of the effective re-charging of the anode materials in lithium ion batteries used in automobile and in like applications in which the cells of the battery are repeatedly being discharged and re-charged.

### SUMMARY

An understanding of the practice of the subject invention is based on careful attention being given as to how the anode material is affected as lithium is re-intercalated into it during charging of the lithium-ion electrochemical cell.

By way of example and illustration, many lithium-ion battery cells are composed of small particles of graphite as the anode material, small particles of lithium nickel manganese cobalt oxide (LiNiMNCoO₂) as the cathode material, and LiPF₆ (often 1 M), dissolved in a mixture of non-aqueous solvents, as a liquid electrolyte that permeates and contacts the surfaces of the particulate electrode materials and of a thin porous polymeric separator inserted between them. The graphite anode particles, sometimes mixed with electrically conductive carbon particles, are often resin-bonded in a porous layer of uniform thickness to both major sides of a copper foil current collector. The lithium nickel manganese cobalt oxide particles, optionally mixed with smaller conductive carbon particles, are resin-bonded in a porous layer of uniform thickness to both major surfaces of an aluminum current collector foil. The electrodes are often formed as like-sized rectangles, upstanding in an alternating assembly, with an uncoated tab or tabs at their top sides for electrical connection to other electrodes in a cell package. The anode tabs and the cathode tabs may be separately joined to a common anode and cathode terminal for a group of battery cells.

A group of a predetermined number of anodes and cathodes are assembled in a suitable close-fitting container which is then filled with the electrolyte solution as the container is being closed. The electrolyte is inserted into the assembly of alternating opposing electrodes so as to suitably infiltrate and fill the pores of each layer of electrode material such that substantially each particle of electrode material is contacted and wetted by the electrolyte solution with its predetermined concentration of lithium ions. Typically, only the respective terminals extend outside the finished and closed package of assembled cell units.

But the terminals are used in delivering direct current to the electrical power consuming devices connected to the battery and to receive electrical current for recharging the battery. And the terminals are also used for connections to controls, instrumentation and computer data storage and processing for several functions, including assessing the state of charge of the battery and for initiating re-charging of the cells of the battery.

The following discussion pertains to management of the operation of a lithium battery formed of lithium-ion cells in which the anode material is based on micrometer-size particles of graphite. At some stage in the preparation of each anode it is necessary to intercalate the particles of carbon with lithium. And a like practice is involved each time a lithium-depleted anode (following each cell discharge cycle) is re-charged by the application of a suitable reverse voltage between the cathode (now a minus DC charge) and the anode (now a plus DC charge) for the purpose of re-intercalation of lithium into each graphite particle (or other suitable anode material) of the porous anode material layer.

During charging of the lithium cell, lithium ions are intercalated from the surrounding liquid electrolyte onto the surfaces of the small layered graphite particles of the anode material. In graphite, the carbon atoms are arranged in layers, in which each carbon atom is bonded to three others by single or double covalent bonds. The lithium ions encounter electrons entering the graphite particles of the anode from the flow of charging current and react with the carbon (graphite) particles to form an intercalation compound per the following equation:

xLi⁺+xe⁻+C₆→LiₓC₆ (0≤x≤1)

Thus, six carbon atoms of the graphite crystal structure can accommodate up to one lithium atom in the intercalation process, driven by the applied charging potential. By this process, the initial anode material of graphite particles is filled with (accommodates) lithium atoms at the existing reaction rate established by the environmental conditions at the anode site. And after an operating cell is substantially discharged by the depletion of the lithium content of the anode, by transferring it to the cathode, the lithium content is restored in the graphite particles by a like re-charging process.

However, during operating battery recharging processes, it is sometimes found that not all the lithium entering the anode material is accommodated into the graphite particles in the LiC₆ intercalation form. Sometimes, lithium metal is simply plated on the surfaces of the graphite particles. Some lithium ions collect an electron and simply form plated lithium metal. This is an undesirable result of the charging process. The plated lithium metal does not function in the anode material in the same manner as the lithium content of the LiC₆ composition. The plated lithium metal reduces the electrical capacity of the cell and has its own electrochemical voltage potential which also interferes with the basic function of the lithium-ion battery cell. Further, some of the plated lithium tends to react with the electrolyte to yield an inert product containing lithium, and that reacted lithium product is no longer available to function in the cell. The cell loses a small amount of capacity and, over time, this can lead to early cell failure. If a lot of lithium is plated, the reactions with the electrolyte solvent can be severe, including a rapid thermal event. And the plated lithium can form a dendrite extending from the anode and electrically shorting the cell.

In accordance with practices of this invention, the re-charging process is managed so as to improve the rate and the efficiency of the intercalation of lithium back into the anode graphite particles, with the lithium being present in the LiC₆ composition.

In accordance with research work leading to this disclosure, it was observed that the charging rate of the graphite with lithium ions can lead to the following scenarios. Lithium fills the host graphitic carbon in accordance with the above reaction equation by forming LiC₆. But the rate of lithium addition (i.e., transfer from the electrolyte solution) to the surfaces of the graphite particles may exceed the rate of lithium incorporation into the graphite crystal structure as LiC₆. As the charging process continues, lithium metal saturates the available surface sites of the graphite particles and then accumulates on the surfaces of the particles. Upon cessation of the charging current, the lithium may slowly diffuse into the graphite particles. But with the presence of the plated lithium, the negative electrode potential has been altered. The negative electrode potential is temporarily (at least) closer to that of a lithium metal anode than to its intended higher potential of the LiC₆ anode material. It is found that as the lithium gradually diffuses into the graphite material, forming LiC₆, the potential of the anode gradually rises to its intended level as if no lithium had plated. It is found that the anode potential continues to relax to an equilibrium value as the concentration profile of lithium metal on the graphite particles continues to diminish or vanish after a period of time.

But in an assembly of battery cells intended, for example, to power an electric motor to drive the wheels of a vehicle, the presence of plated lithium metal on the graphite anode particles, even if temporary, is undesirable. The battery may be placed in its operational discharge mode while the plated lithium is still present and the function of the battery cells is compromised. It is important in the operation of a battery in such a working environment that the re-charging process, often rapid, be monitored and managed to minimize the plating of lithium (or any like metal in a battery cell anode) during the critical re-charging cycle of battery operation.

Thus, in accordance with practices of this invention, the charging of the battery is monitored, such as under the control of a suitably programmed computer in the vehicle or in another device having a motor or other like load bearing machine. In this example, the battery will be formed of an anode cell, or group of anode cells formed of graphite particles as the active anode material. And the cathode material and liquid electrolyte will be compatible with the graphite anode material. The applied charging current is controlled at varying levels; such as charging levels above, at, or below a 1 C charging level for the battery cell(s). The charging current will be continually measured and the data delivered to the programmed computer, commonly at a rate of 0.1 seconds per current-potential-time data point. And the voltage potential of the anode with respect to the cathode (V_{cell}) will be measured and the data transmitted to the programmed computer. The voltage potential will be measured during the charging of the anode cell(s) and during open-circuit periods immediately following charging periods. In addition, the voltage potential of the anode (negative electrode, V_{neg}) vs. a lithium metal reference electrode may also be measured during the charging of the anode cell(s) and during open-circuit periods immediately following charging periods. The programmed computer associated with the management of the charging process will also be programmed to calculate the derivatives of the change in voltage of the cell (V_{cell}) with time (t, in seconds) during open-circuit periods following a charge period (dV_{cell}/dt), and to calculate the derivatives of the change in voltage of the anode (negative electrode) vs. a lithium reference electrode (Vn_{neg}) with time (t, in seconds) following a charge period (dV_{neg}/dt).

Monitoring and management of the charge process for the graphite anode(s) proceeds as follows. The operator of a vehicle using a battery for at least part-time powering of an electric drive motor may initiate a charge cycle when the vehicle is idle. Or the vehicle may have on-board charging means such as an engine-powered generator and /or means associated with vehicle braking. When the programmed computer determines that recharging of the battery is available or appropriate, a charging cycle is initiated at a charging level based on a predetermined value of C (amperes per hour), where C is a predetermined current charge level that will fully re-charge a discharged cell, of known electrode materials and amounts, in one hour. The determined charging rate is usually based on a multiple of C, for example 0.4 C or 1.4 C. The applied charging level may be based on the computer-stored experience of previous charging cycles of the battery.

During the charging, the computer may be tracking and storing the cell potential (V). Following a predetermined period of charging at the initial charging rate, the charging is ceased, with the cell or battery in an open-circuit mode. During the open-circuit stage, the derivative of the cell voltage with time (dVcell/dt) over a predetermined period of seconds is determined and stored. Alternatively, or in combination, the derivative of the negative electrode potential vs. Li (dVneg/dt) is determined and stored in the programmed computer. This data is obtained at a measured ambient temperature when the vehicle is not operating, or at a measured temperature in the moving vehicle. If a bump or discontinuity (abrupt change in direction of the sensed and calculated derivative data) in either derivative curve is found, it is attributed to un-wanted plating of lithium metal on the graphite particles of the anode as it is being charged. The charging process is either stopped for a pre-determined period to allow the plated lithium to be reacted with the graphite, or is re-started at a lower charge rate (C) selected to better balance the rate of deposition of the lithium onto the graphite particles with the rate of assimilation of the lithium into the graphite material as LiC₆.

Thus, in accordance with practices of this invention, the charge rate of the graphite cell(s) of a lithium-ion battery is determined based on the presence or absence of a local minimum (a bump-like discontinuity) in the curve (the derivative curve) of either (dV_{cell}/dt) or (dV_{neg}/dt). As will be discussed and described in more detail below in this specification, the presence of such a discontinuity in the cell potential or negative electrode potential is a timely indication of the presence of lithium on the surfaces of the graphite particles of the anode of the cell(s). This selected derivative data indicates that the rate of deposition of lithium from the cell electrolyte onto the surface of the graphite particles is greater than the rate at which the lithium is being assimilated as LiC₆ in the anode material.

Practices of methods of this invention will be described in more detail in the following sections of this specification. Reference will be made to the drawings which are described in the following section of this specification.

### BRIEF DESCRIPTION OF THE DRAWINGS

FIG. 1 is a graph of Cell Potential (V) (left vertical axis) vs, time in hours (h) for a lithium-ion cell having a graphite anode and a lithium nickel manganese cobalt oxide cathode, during charging at 20° C. at 0.85 C charge rate, for a first period of time, and for a second period of time at open-circuit operation. The right vertical axis reflects values of (i) 100 (charging current, A), (ii) negative electrode (anode) potential (both during charging and during open-circuit mode) vs. a lithium reference electrode (V), and (iii) dV(cell)/dt in mV/s.

FIG. 2 is a graph of Cell Potential (V) (left vertical axis) vs, time in hours (horizontal axis) for a lithium-ion cell having a graphite anode and lithium nickel manganese cobalt oxide cathode, during charging at 25° C. at 0.428 C charge, for a first period of time, and for a second period of time at open-circuit operation. The right vertical axis reflects values of (i) 100 (current, A), (ii) negative electrode (anode) potential vs. a lithium reference electrode (V), and (iii) dVcell/dt in mV/s. The compositions and structures of the respective test cells were the same.

FIGS. 3 and 4 present the open circuit data over a shorter period of time than the graphs of FIGS. 1 and 2 for both the lithium-ion cell charged at 0.85 C and the lithium-ion cell charged at 0.428 C. The time duration of the open-circuit period (horizontal axes) in FIG. 3 is 3600 seconds (one hour) and in FIG. 4 is 600 seconds (ten minutes). The graphs of both FIG. 3 and FIG. 4 present the cell potential in Volts (V), left vertical axis, for both the cell charged at 0.85 C and the cell charged at 0.428 C. The right vertical axes for the graphs of FIGS. 3 and 4 present (i) the negative electrode (anode) potential vs. a lithium reference electrode, Li(V), (ii) the values of dV/cell/dt, and (iii) the values of dVneg/dt, the values of each derivative curve in mV/s.

### DETAILED DESCRIPTION

The following tests were conducted in two identical cells which were representative of the many cells assembled for a large battery pack for an electric vehicle. Each of the 288 cells for the battery pack comprises a graphite anode and a lithium nickel-manganese-cobalt oxide cathode that as-assembled in a vehicle battery pack are collectively capable of producing a potential of about 350 V and 180 ampere hours. The electrolyte was a 1M solution of LiPF₆ in a mixture of organic solvents. The two subject test cells were prepared to present about 1/7200^{th} of the cell area of such a battery pack. Each test cell comprised an anode disk of graphite, a cathode disc of lithium nickel-manganese-cobalt oxide, and a lithium reference disk placed in the 1M LiPF₆ electrolyte solution.

The two test cells each had a nominal voltage of 3.65V and were cycled between a minimum of 2.5V and a maximum of 4.18V. Anode voltages (negative electrode during cell discharge) were also measured against the metallic lithium reference electrode. The testing of the cells indicated that capacity and power performance matched the full-sized cell when the scaling factor was taken into account.

The following tests were conducted on the charging of a lithium-ion battery cell formed of an anode formed of porous layers of graphite particles resin-bonded to both sides of a copper foil current collector and a cathode formed of porous layers of lithium nickel manganese cobalt oxide particles resin-bonded to both sides of an aluminum current collector foil. The electrodes were or like rectangular shape and assembled face-to-face, separated by a thin porous polymeric separator of like shape. The pores of the assembled cell materials were infiltrated and filled with an electrolyte solution formed of a 1M solution of LiPF₆ dissolved in a mixture of organic solvents.

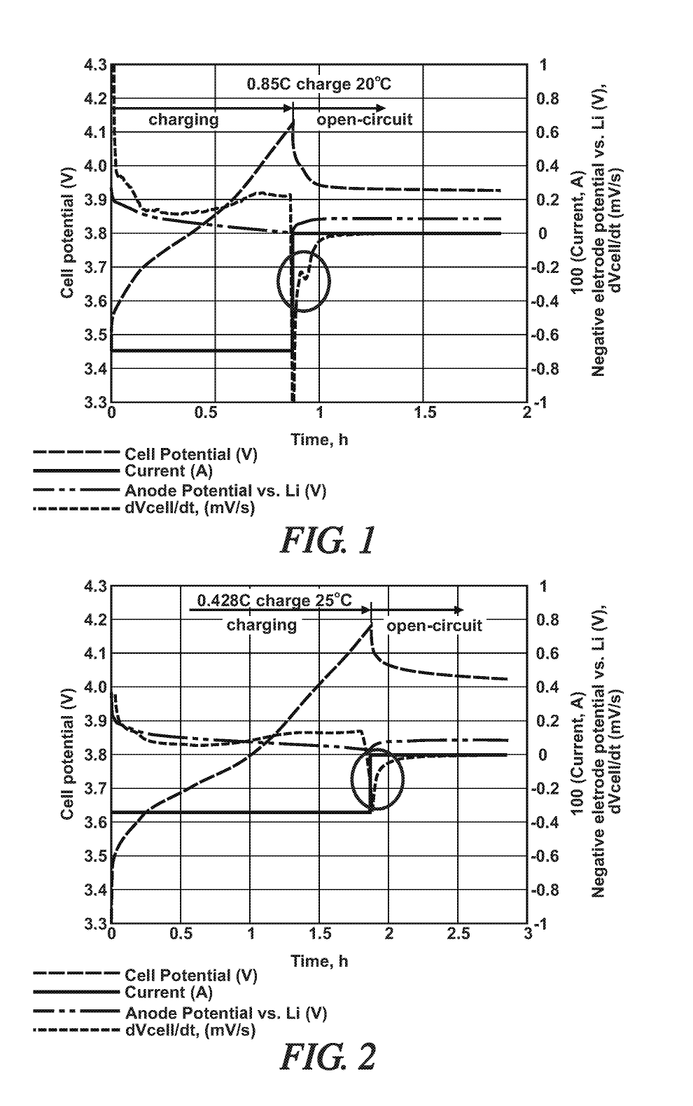

Data obtained for the first battery cell, during a 54-minute charging period and a 66-minute open-circuit period (following charging), is presented in FIG. 1. The initial state of charge (SOC) of the cell was 5%. The temperature of the cell was 20° C. The first battery cell was charged with an initial potential of about 3.5 V DC and a current of about 0.007 amperes. These conditions amounted to a 0.85 C rate for the cell. The charging was then stopped and the cell was left in an open-circuit mode. FIG. 1 is a graph that summarizes the charge current (curve) and the cell potential (V) during the charging period. As is presented in FIG. 1, the charge potential increased from about 3.5 V to about 4.1 V during the charging period. At the termination of this charging time, the open-circuit cell potential (V) was initially about 4.1 V, but it quickly fell off to about 3.93V. During the open-circuit period of this test (just over one hour), the anode (negative electrode) potential vs. a lithium reference electrode was also measured and found to be about 0.1 V as recorded in the data presented in FIG. 1.

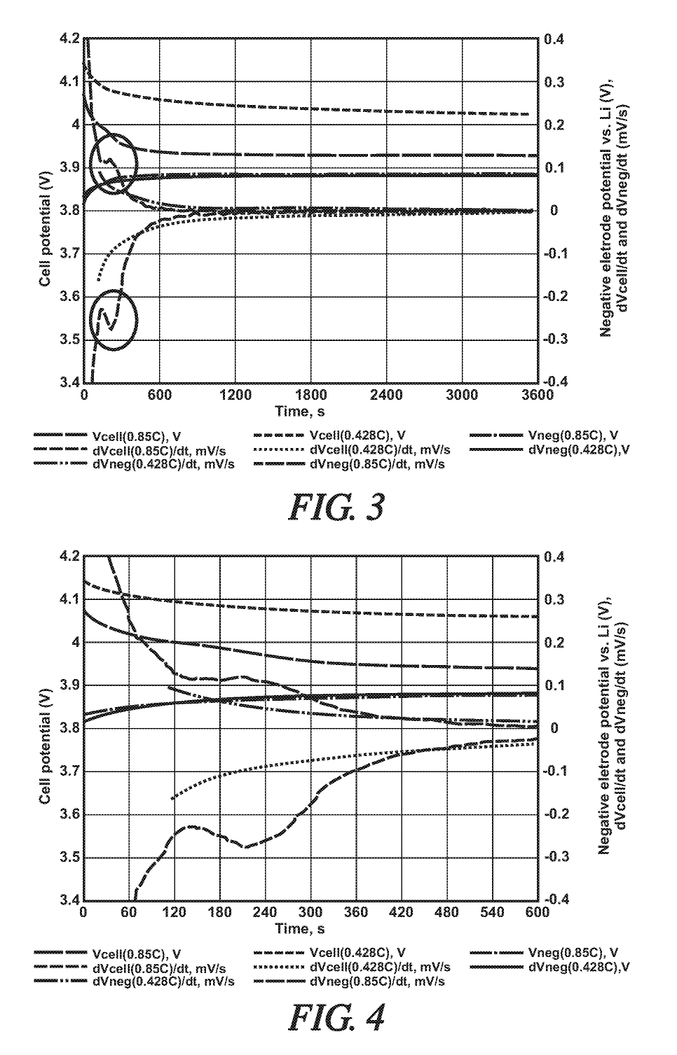

In addition to obtaining and recording the cell potential during charging and the open-circuit period, the derivative of the change in cell potential with time, dVcell/dt (mV/s), was determined. This derivative data is presented as the in FIG. 1 (and in FIGS. 3-4). It is noted that the portion of the derivative curve pertaining to the open-circuit cell voltage increases quickly (lower negative values) with time. But, as seen in the graph of FIG. 1, the derivative curve (approaching a zero value) reaches a momentary peak, experiences a local drop and minimum, (circled area) and then displays less negative values as it approaches zero.

Charging experiments with lithium-ion battery cells having graphite anode materials and compatible cathode materials have demonstrated that the formation of lithium plating on the graphite anode material is associated with such a bump or local minimum in the derivative of the cell potential with time, dV(cell)/dt (mV/S), as again shown in the circled region of the derivative curve as presented in FIG. 1. Indeed, the first cell was taken apart and examined at the conclusion of the open-circuit evaluation and was found to have physical evidence of lithium plating on the particles of graphite anode material. This occurred at the 0.85 C charge rate.

The data presented in FIG. 2 was obtained using a duplicate lithium-ion battery cell as used in FIG. 1 and charging it at 25° C. But the charge rate was lower, only 0.428 C. The charging current was 0.0035 amperes over a period of about 1.8 hours. The cell potential during the charge period increased from about 3.3V, increasing to 4.2V. During the open-circuit period, the cell potential fell to about 4V. During the charging period, the potential (V) of the anode vs. the lithium metal reference electrode declined from about 0.2 volts to about zero volts. During the open-circuit period, the anode potential rapidly increased to about 0.1V and remained at that level. The value of dV_{cell}/dt during the charging period was found to hold a fairly steady value. And during the open-cell period the value of dV_{cell}/dt simply increased from an initial value of about −0.3 in a smooth curve to its zero value. Thus, the derivative curve of FIG. 2, presented no bump or local minimum (circled area) indicative of lithium plating. Physical examination of the charged cell, following the open-circuit period confirmed that no lithium had been plated. Accordingly, the lower charging rate (0.428 C) was such that lithium was intercalated into the anode material as LiC₆.

Thus, the evidence of the absence of lithium plating at the reduced charging rate was demonstrated both by physical examination of the second test cell and by the data obtained in preparing and analyzing the data in the derivative curve for the cell potential, dV_{cell}/dt, during the open-circuit period. And this information was obtained early in the open-circuit period, within the first few minutes.

FIGS. 3 and 4 present additional data, relative to potential lithium plating on graphite anode material, obtained from the lithium ion battery cells described above. The first cell was charged at 0.85 C which was found to lead to the plating of lithium metal on the graphite of the anode. The second cell was charged at 0.428 C, only about half the charge rate for the first cell and no lithium plating was indicated by the derivative curve dVcell/dt or by physical examination of the charged cell. In FIGS. 3 and 4, data for both cells are combined during the open-circuit mode and a shorter time period presented in the respective graphs.

In each of FIGS. 3 and 4, the cell potential (Vcell), the potential of the anode (neg.) vs. a lithium reference electrode (Vneg), and the differentials (dV_{cell}/dt) and (dV_{neg}/dt) are presented for the lithium ion battery cell charged at 0.428 C and for the lithium ion test cell charged at 0.85 C. In FIG. 3, the total open-circuit time period is 3600 seconds and in FIG. 4 the total open-circuit time period is 600 seconds. But the data is presented over the same width of the drawing sheet, so that the derivative curves in FIG. 4 are stretched in the presented data.

Still the derivative curves with respect to time for each of Vcell and Vneg display an abrupt local inflection the derivative curves (circled areas) with respect to the lithium-ion cell when it was charged at the 0.85 C rate. Each derivative curve for the 0.85 C rate reflects the presence of lithium plating, which was confirmed in examination of the anode material. When the cell was charged at its 0.428 C no plating took place and the derivative curves do not contain inflections over the open-circuit period.

Following is a discussion of on-vehicle practices that can be used to monitor the charging of a lithium ion cell with a graphite anode so as to find a maximum charge rate that minimizes the formation and retention of lithium plated on the anode material.

In many situations, a vehicle lithium-ion battery pack will be charged when the vehicle is not being driven. It may be parked in a garage or near another suitable power source for the charging operation. And many such lithium cells utilize graphite anodes (e.g. 288 cells and anodes). A present-day vehicle containing a battery pack sized to power an electric vehicle driving motor also contains computer capacity and supporting instrumentation to manage the cyclical discharging a re-charging of the vehicle battery. The on-vehicle computer-based battery control system and associated instrumentation contain stored values for the state-of-charge of the battery pack and contain reference data from previous charging periods for the on-vehicle battery pack. Such existing on-board equipment may be utilized and expanded as necessary to manage lithium ion battery packs with graphite anodes so as to minimize the plating of lithium onto the graphite particles.

The battery charging program of the vehicle/battery control system will have data concerning the present state of charge (SOC) of the graphite anodes-based battery pack as well as its present temperature, T(e.g., in degrees C.). The present open-circuit voltage (ocv, V) of the battery pack or of a representative cell is also available and stored in the computer. This data set (SOC, T, ocv) may be used as a first charging calibration parameter, cal_a, for recharging graphite anodes with lithium ions in the form of the LiC₆ composition.

Based on the values of the constituents of the calibration, cal_a, the on-vehicle computer is programmed to utilize a stored value (from a look-up table) to set a total charge current value (cal_i) for the charging of the battery pack. The charging program of the on-vehicle computer also has a stored value of a suitable maximum battery pack voltage based on the temperature of the cell, calibration (cal_v: Vₘₐₓ(T).

As the charging of the battery pack proceeds, the total charge current is measured, and SOC and temperature values are updated in the computer storage. The maximum battery pack voltage at the temperature (cal_v, Vₘₐₓ(T) provides a boundary for the duration and termination of the charge period. At this stage, the charging process is stopped and open circuit values of the cell (Vcell) with time (in seconds or less) and/or the potential of the negative (anode) electrode vs. a lithium metal reference electrode (V_{neg}) are measured during the open-circuit period immediately following the charge period.

As stated above in this specification, the charging of a lithium ion battery results in lithium being intercalated into the active anode material. In many such batteries, the active anode material comprises particles of graphite. In order to properly charge the cell, the lithium must be suitably reacted with and assimilated into the graphite as LiC₆. If the charging rate is too fast, some of the lithium is not assimilated as LiC₆, it is plated as lithium metal on the graphite particles. Prior to this work there was no known process for determining whether lithium plating is occurring during the charging process. In some instances, some of the plated lithium metal gradually reacts with the graphite to form LiC₆, but, as described above in this specification, any remaining plated lithium metal is detrimental to the continuing operation of the cell(s).

Practices of this invention make use of our observation that plated lithium metal on the anode graphite-LiC₆ material acts like a competing anode material and affects the cell potential (V_{cell}). And if the graphite anode material is connected with a reference electrode of lithium metal, the lithium-plating affects the potential between the anode (negative electrode) and the reference electrode (V_{neg}). But, during the open-circuit period following the charging process, the presence of plated lithium may be detected by examination of a plot, or accumulated stored values, of dV_{cell}/dt and/or of dV_{neg}/dt, each in mV/s. It is observed that if these derivative values, of the specified potentials with time, present themselves as a bump or discontinuity in the derivative curve, such a discontinuity is evidence of the presence of unwanted plated lithium, incorporated with the LiC₆-containng graphite. Such data and discontinuities in the derivative curves are presented in FIGS. 1, 3, and 4 of this specification. Such discontinuities in the derivative curves typically occur within a period of one to twenty minutes, or so, at the beginning of the open-circuit period. This information, obtained from the derivative curves, may be suitably used in a following battery charging period.

Thus, at the completion of a charging period and at the beginning of an immediately-following open circuit period, the computer-managed charging system monitors dV_{cell}/dt and/or dV_{neg}/dt in mV/s. If no local minimum is found in dV_{cell}/dt or no local maximum is found in dV_{neg}/dt within a predetermined period of open-circuit voltage e.g., calibration parameter cal_b, specified above in this specification, then it may be concluded that no lithium plating has occurred during the previous charging cycle. If there is no evidence of a discontinuity in the derivative curve, a subsequent battery charging program may be conducted at the same charging parameters (cal_i and cal_v) or, possibly faster charging parameters.

But if a local minimum is found in dV_{cell}/dt and/or a local maximum is found in dV_{neg}/dt within a predetermined period of open-circuit voltage e.g., calibration parameter cal_b, then it is necessary to reduce I_{charge}(T,SOC) for the next charge event by reducing the charging current (cal_i) and/or the charging potential (cal_v).

The practice of assessing dV_{cell}/dt and/or dV_{neg}/dt may be performed after a full charging period using previous charging monitoring data. And the gathered derivative-based data may be used by the computer monitoring system, as described, to set the charging calibrations for the next charging period following a substantial period of battery use in powering the vehicle or other device in which it is used. Alternatively, a generally full charging cycle may be interrupted from time-to-time for the purpose of checking for lithium plating and then modifying the charging parameters as necessary to minimize lithium plating while also promoting the rate at which the charging of the battery is accomplished.

As demonstrated, a value of this invention is to provide a monitoring system, associated with the charging of a substantial and large battery system so as to detect and minimize lithium plating onto graphite anode material. While many such systems are used on automotive vehicles, they are also used with other power-consuming devices.

The practice of monitoring lithium plating may also be performed during or after regenerative braking or like on-vehicle charging events. Thus, the practice may also be conducted during low current charge events (e.g. 0.1 C events. Such low charge events are considered as equivalent to open-circuit periods in practices of this invention.

And while the practice of the subject monitoring process, using derivatives of voltage potentials with time, has been demonstrated with respect to the intercalation of lithium into graphite anodes, the monitoring process is likewise applicable to processes of intercalating magnesium and/or sodium into graphite particles for electrodes or other applications. Also, the monitoring process is applicable to the intercalation of these metals (lithium, magnesium, or sodium) into silicon-graphite anodes.

1. A method of monitoring the intercalation of lithium into particles of graphite in the anode of a lithium-ion battery cell during charging of the battery cell, the lithium battery cell also comprising a cathode, separated from the anode, and a lithium ion-containing electrolyte in contact with the graphite particles of the anode and with the cathode, the battery cell optionally having a reference electrode of lithium metal, the charging of the lithium-ion battery cell being accomplished by the application of (i) a specified voltage potential applied to the anode and cathode and (ii) a specified total charging current, carrying lithium ions to the graphite particles for the purpose of incorporating lithium into the graphitic carbon as LiC₆, the purpose of the monitoring method being to detect the unwanted plating of metallic lithium on the graphite particles rather than the formation of LiC₆, the monitoring method comprising:
maintaining the battery cell in an open-circuit state for a specified time period following the charging of the battery cell; and during the time period,
measuring the open-circuit cell voltage (V_{cell});
determining the derivative of the open-circuit cell voltage with time (dVcell/dt, mV/s);
examining the derivative data collected over the specified time period to determine whether the data presents a smooth curve or a curve with a local discontinuity, the smooth curve indicating the absence of lithium plating, a curve with a local discontinuity indicating the presence of lithium plating; and, thereafter,
using the derivative data in determining the specified voltage potential or the total charging current for a subsequent intercalation of lithium into the graphite anode material.

2. A method of monitoring the intercalation of lithium into particles of graphite in the anode of a lithium-ion battery cell during charging of the battery cell as stated in claim 1 in which the derivative data is collected and analyzed during the first one to twenty minutes of an open-circuit period.

3. A method of monitoring the intercalation of lithium into particles of graphite in the anode of a lithium-ion battery cell during charging of the battery cell as stated in claim 1 in which the derivative data presents a smooth curve and the subsequent charging process is conducted at the same charging conditions.

4. A method of monitoring the intercalation of lithium into particles of graphite in the anode of a lithium-ion battery cell during charging of the battery cell as stated in claim 1 in which the derivative data presents a smooth curve and the subsequent charging process is conducted at more aggressive charging conditions.

5. A method of monitoring the intercalation of lithium into particles of graphite in the anode of a lithium-ion battery cell during charging of the battery cell as stated in claim 1 in which the derivative data presents a curve with a local discontinuity indicating the presence of lithium plating and the subsequent charging process is conducted at less aggressive charging conditions.

6. A method of monitoring the intercalation of lithium into particles of graphite in the anode of a lithium-ion battery cell during charging of the battery cell as stated in claim 1 in which the open circuit voltage of the anode vs. the reference electrode is measured (V_{anode}) and the derivative values of dV_{anode}/dt are determined and used to determine the specified voltage potential or the total charging current for a subsequent intercalation of lithium into the graphite anode material.

7. A method of charging a lithium-ion battery cell which comprises (i) a first electrode formed of a porous layer of particles of graphite, the first electrode functioning as a negatively-charged anode during discharge of the battery cell, at least a portion of the particles of graphite being characterized by the presence of LiC₆ when the battery cell is in a charged state, the graphite particles being depleted of LiC₆ as the battery cell is being discharged, (ii) a second electrode physically separated from the first electrode and being formed of an electrode material electrochemically compatible with the graphite particles, the second electrode functioning as a cathode during discharge of the battery cell and (iii) an electrolyte solution comprising mobile lithium ions, the electrolyte solution being in contact with both electrodes, the charging method comprising:
applying a predetermined direct current charging-potential for a predetermined period of time between the first and second electrodes so as to direct lithium ions in the electrolyte solution into contact with the graphite particles of the first electrode for the purpose of reacting lithium ions with electrons on the graphite particles and forming LiC₆ in the graphite particles;
terminating the charging current and placing the lithium-ion battery cell in an open-circuit state;
measuring, over a first predetermined period of time (t, in seconds) of the open-circuit state, at least one of (i) the open-circuit cell voltage (V_{cell}) and (ii) the voltage of the negative electrode vs. a lithium metal reference electrode (V_{neg}) to obtain a voltage curve vs. time for V_{cell} or V_{neg}.
preparing a derivative curve for dV_{cell}/dt or dV_{neg}/dt;
examining the derivative data collected over the specified time period to determine whether the data presents a smooth curve or a curve with a local discontinuity, a local maximum, the smooth curve indicating the absence of lithium plating, a curve with a local discontinuity indicating the presence of lithium plating; and, thereafter,
using the derivative data in determining the specified voltage potential or the total charging current for a subsequent of the graphite anode material.

8. A method of charging a lithium-ion battery cell as stated in claim 7 in which the derivative data is collected and analyzed during an open circuit state period of one to twenty minutes.

9. A method of charging a lithium-ion battery cell as stated in claim 7 in which the derivative data for dV_{cell}/dt presents a smooth curve and the subsequent charging process is conducted at the same charging conditions.

10. A method of charging a lithium-ion battery cell as stated in claim 7 in which the derivative data for dV_{cell}/dt presents a smooth curve and the subsequent charging process is conducted at more aggressive charging conditions.

11. A method of charging a lithium-ion battery cell as stated in claim 7 in which the derivative data for dV_{cell}/dt presents a curve with a local discontinuity indicating the presence of lithium plating and the subsequent charging process is conducted at less aggressive charging conditions.

12. A method of charging a lithium-ion battery cell as stated in claim 7 in which the derivative data for dV_{neg}/dt presents a smooth curve and the subsequent charging process is conducted at the same charging conditions.

13. A method of charging a lithium-ion battery cell as stated in claim 7 in which the derivative data for dV_{neg}/dt presents a smooth curve and the subsequent charging process is conducted at more aggressive charging conditions.

14. A method of charging a lithium-ion battery cell as stated in claim 7 in which the derivative data for dV_{neg}/dt presents a curve with a local discontinuity indicating the presence of lithium plating and the subsequent charging process is conducted at less aggressive charging conditions.

15. A method of monitoring the intercalation of a metal into particles of graphite or of graphite and silicon in the anode of a battery cell during charging of the battery cell, the metal being one selected from the group consisting of lithium, magnesium, and sodium, the battery cell also comprising a cathode, separated from the anode, and a metal ion-containing electrolyte in contact with the graphite or graphite-silicon particles of the anode and with the cathode, the charging of the battery cell being accomplished by the application of (i) a specified voltage potential applied to the anode and cathode and (ii) a specified total charging current, carrying metal ions to the graphite or graphite-silicon particles for the purpose of incorporating the metal into the graphite or graphite silicon particles, the purpose of the monitoring method being to detect the unwanted plating of the metal on the anode particles, the monitoring method comprising:
maintaining the battery cell in an open-circuit state for a specified time period following the charging of the battery cell; and during the time period,
measuring the open-circuit cell voltage (V_{cell});
determining the derivative of the open-circuit cell voltage with time (dVcell/dt, mV/s);
examining the derivative data collected over the specified time period to determine whether the data presents a smooth curve or a curve with a local discontinuity, the smooth curve indicating the absence of metal plating, a curve with a local discontinuity indicating the presence of metal plating; and, thereafter,
using the derivative data in determining the specified voltage potential or the total charging current for a subsequent intercalation of the metal into the graphite or graphite-silicon particles of anode material.

16. A method of monitoring the intercalation of a metal into particles of graphite or of graphite and silicon in the anode of a battery cell during charging of the battery cell as stated in claim 15 in which the derivative data is collected and analyzed during the first one to twenty minutes of an open-circuit period.
